(19) United States
(12) Patent Application Publication
(10) Pub. No.: US 2006/0130382 A1
(43) Pub. Date: Jun. 22, 2006

(54) Light for illuminating a real estate sign

(76) Inventors: William R. Howell, San Jose, CA (US); Donald C. Howell, San Jose, CA (US)

Correspondence Address: Cahill, von Hellens & Glazer P.L.C., 155 Park One, 2141 E. Highland Avenue, Phoenix, AZ, 85016, US

(21) Appl. No.: 11/022,508

(22) Filed: Dec. 22, 2004

(51) Int. Cl. G09F 15/02

(52) U.S. Cl. 40/607.09

(57) ABSTRACT

A lighting apparatus includes a battery charged during daylight hours by a conventional solar collector. A panel or reflector is attached to the arm of a conventional post and arm supporting in a depending manner a real estate sign. The reflector may include a partial cylindrical section at each opposed end for supporting an elongated lamp and for reflecting the light from the lamp onto the real estate sign disposed between the opposed ends of the reflector. A photocell interconnects the lamps with the battery to energize the lights and illuminate the real estate sign during periods of darkness.

### CROSS REFERENCE TO RELATED APPLICATIONS

The present application is related to an application for design patent entitled “LIGHT SYSTEM FOR REAL ESTATE SIGN”, filed Oct. 29, 2004, assigned Ser. No. 29/216,193 and describing an invention made by the present inventors.

### BACKGROUND OF THE INVENTION

1. Field of the Invention

The present invention relates to lights for signs and, more particularly, to a lighting apparatus for use in conjunction with a conventional real estate sign advertising the sale or lease of a property.

2. Description of Related Prior Art

Conventional real estate signs used throughout the nation include a post anchored in the ground and supporting a laterally extending arm. A sign is detachably attachable to the arm and depends downwardly therefrom. Usually, the mode of attachment is a pair of hooks extending upwardly from the sign for engagement with screw eyes depending from the arm.

Most conventional real estate signs are not lighted and such lack of lighting renders the signs unreadable during periods of darkness. Yet, many potential buyers or lessors of real estate drive by areas of interest to them during periods of darkness and but cannot readily read the information on the signs. To overcome this problem, the signs may be located in a lighted area or may be illuminated by a ground or post mounted or other light, whether it be a floodlight or a spotlight.

### SUMMARY OF THE INVENTION

The present invention is directed to lighting apparatus for use with a conventional real estate sign to illuminate the sign automatically during periods of darkness. A solar collector (solar cell) may be mounted on a post supporting an arm from which the sign depends to convert solar radiation into an electrical charging signal. A battery connected to the solar collector is charged during daylight hours to provide electrical power to a pair of lights during darkness. A reflector is attached to the underside of the arm and extends in opposed directions. A partial cylindrical section is disposed at each end of the reflector to support an elongated lamp located therein. Each of the lamps is connected to the battery through a photocell to transmit electrical power from the battery to the lamps during periods of darkness. The cylindrical sections are oriented to reflect light from the respective lamp onto the sign depending from the arm to augment the direct illumination provided by each respective lamp.

It is therefore a primary object of the present to provide a lighting apparatus for illuminating a real estate sign during periods of darkness.

Another object of the present invention is to provide a lighting apparatus that automatically illuminates a real estate sign during periods of darkness.

Still another objection of the present invention is to provide a lighting apparatus for a real estate sign having a solar collector for charging a battery that provides electrical power to the lighting apparatus during periods of darkness.

Yet another object of the present invention is to provide a reflector for supporting battery powered lamps to reflect light therefrom and illuminate a real estate sign.

A further object of the present invention is to provide a lighting apparatus useable with any conventional real estate sign to illuminate the sign during periods of darkness.

A still further object of the present invention is to provide a lighting apparatus adapted to be attached to any conventional real estate sign to automatically illuminate the sign during periods of darkness.

A yet further objection of the present invention is to provide a method for automatically illuminating a real estate sign during periods of darkness.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIG. 1 is an isometric view of a lighting apparatus attached to a conventional real estate sign;

FIG. 2 is a cross sectional view taken along lines 2-2, as shown in FIG. 1;

FIG. 3 is a bottom view of a reflector; and

FIG. 4 illustrates the solar collector and battery for providing power to the lighting apparatus.

### DESCRIPTION OF THE PREFERRED EMBODIMENT

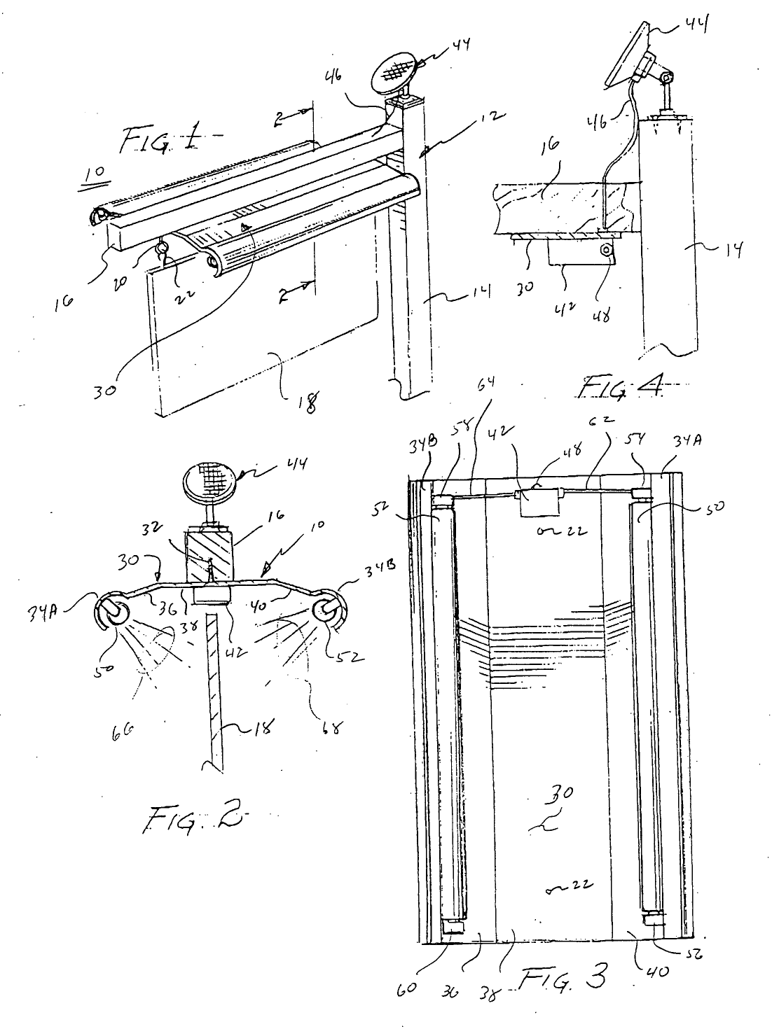

Referring to FIG. 1, there is shown a lighting apparatus 10 attached to a conventional real estate sign assembly 12. Such an assembly generally includes a post 14 anchored in the ground and supporting a horizontal arm 16. Usually, a sign 18 is dependingly supported from arm 16 by a pair of screw eyes 20 depending from the arm and engaged by hooks 22 extending upwardly from sign 18. As is common in the real estate industry, screw eyes 20 are a fixed standard distance apart from one another. Widely used signs 18 have hooks 22 set apart from one another by a distance equivalent to that of a distance between the screw eyes. Thereby, the post and arm assembly can be used to support signs of various realtors.

A real estate sign 18 conveys indicia reflective of the attendant property being sold or leased. It usually includes the name of the realtor listing the property along with information for contacting the realtor. Such information is readily viewed and read during daylight hours. However, during periods of darkness the information is generally not visible unless a viewer uses a flashlight or the like. As many potential purchasers and lessors of real estate find themselves, by design or by happenstance, in areas of potential interest to them, a real need exists to advise such persons of the availability of a piece of property and related contact information.

As particularly shown in FIGS. 1 and 2, lighting apparatus 10 includes a panel or reflector 30 secured to the underside of arm 16 by screws 32 or the like. The reflector extends in opposed directions and each end of the reflector is terminated by one of partial cylindrical sections 34A, 34B. The reflector may include one or more panels 36, 38 and 40 disposed intermediate the two cylindrical sections. Preferably, these panels are light reflective. A battery 42 may be secured to the underside of a reflector 30, as shown; however, it may be located elsewhere, such as in combination with solar collector 44. The solar collector may be attached to the top of post 14, as illustrated in FIG. 1, or may be attached to the top of arm 16, as shown in FIG. 2. The solar collector converts solar radiation impinging thereon into an electrical current. The electrical current is conveyed to battery 42 via an electrical conductor 46 (see FIG. 1) to charge the battery during daylight hours; circuitry for controlling or regulating the charging current may be incorporated. During periods of darkness, a photocell 48 (as shown in FIGS. 3 and 4) electrically interconnects battery 42 with light fixtures or lamps 50, 52 supported within cylindrical sections 34A and 34B, respectively.

Further details of the invention will be described with additional reference to FIGS. 3 and 4. Lamp 52 may be of the conventional florescent type configured to produce illumination upon application of direct current power from battery 42. This lamp is supported by conventional florescent tube mountings 54, 56 extending from cylindrical section 34A. Similarly, lamp 52 may be of the florescent type and supported by conventional mountings 58, 60 extending from cylindrical section 34B. An electrical conductor 62 extends from battery 42 to electrically interconnect lamp 50 with the battery through photocell 48. Similarly, electrical conductor 64 extends from battery 42 to electrically interconnect lamp 52 with the battery through the photocell.

After battery 42 has been charged by the electrical charging current provided by solar collector 44 and conveyed to the battery through conductor 46, the battery will have sufficient electrical power to energize lamps 50, 52 for a period of time. Upon onset of darkness, photocell 48 will sense the low level of light and interconnect battery 42 with each of lamps 50, 52 via electrical conductors 62, 64, respectively. The lamps will become energized and provide illumination as a function of the number of ampere hours of power stored in the battery. For all practical purposes, such illumination is generally not required for more than a few hours in the evening of each day.

Light 66 provided by lamp 50 will illuminate the corresponding side of sign 18 to render it viewable and readable. This light may be enhanced by a reflective surface disposed on the interior surface of cylindrical section 34A. Further enhancement in the nature of light reflectivity onto the sign may be provided by a reflective surface disposed on panels 36 and 38. Similarly, light 68 from lamp 52 will illuminate the corresponding side of sign 18. The illumination of the sign may be enhanced by providing a reflective surface on the interior of cylindrical section 34B and on panels 40, 36. To enhance illumination of each side of the sign, it is preferable that each partial cylindrical section be oriented such that an imaginary plane extending along a radial from the midpoint of each partial cylindrical section through the axis of rotation of the partial cylindrical section would intersect the sign along its midpoint.

By inspection, it will become apparent that lighting apparatus 10 may be added to any existing conventional real estate sign by simply attaching lighting apparatus 10. That is, reflector 30 and its supported battery 42 can be readily screwed to the underside of arm 16 and solar collector 44 can be readily attached to either post 14 or arm 16 in the conventional manner. The interconnection of the solar cell with the battery and/or photocell 48 via electrical conductor 46 is well within the skill of an artisan.

We claim:

1. Lighting apparatus supported by an arm of a conventional real estate sign and extending from a post anchored in the ground for illuminating a sign depending from the arm, said apparatus comprising in combination:
a) a reflector adapted to be secured to the arm;
b) a partial cylindrical section disposed along each opposed end of said reflector;
c) an elongated lamp mounted with each of said partial cylindrical sections;
d) a solar collector for collecting solar energy and generating a charging current; and
e) a battery adapted to be charged by said solar cell for energizing each of said lamps.

2. The apparatus as set forth in claim 1, including a photocell for selectively interconnecting said battery with each of said lamps during periods of darkness.

3. The apparatus as set forth in claim 1 wherein said solar collector is mounted on the post.

4. The apparatus as set forth in claim 3 wherein said battery is supported by the arm.

5. The apparatus as set forth in claim 1 wherein said reflector includes a plurality of light reflective panels intermediate said partial cylindrical sections.

6. The apparatus as set forth in claim 1 wherein each of said lamps is of a tubular configuration.

7. The apparatus as set forth in claim 1 wherein each of said partial cylindrical sections is a half cylinder and wherein a plane extending along a radial extending from the mid point of each of said sections would intersect the sign.

8. The apparatus as set forth in claim 1 wherein each of said partial cylindrical sections is oriented to reflect light from the respective one of said lamps mounted therein to the sign.

9. A method for lighting a real estate sign depending from an arm supported by a post anchored in the ground, said method comprising the steps of:
a) providing electrical power from a battery;
b) further providing an electrical charging current to the battery with at least one solar collector;
c) selectively energizing a lamp disposed on each side of the sign with electrical power from the battery;
d) supporting each of the lamps from a panel secured to the arm; and
e) radiating light from each of the lamps onto opposed sides of the sign.

10. The method as set forth in claim 9, including the steps of controlling the energization of the lamps to periods of darkness.

11. The method as set forth in claim 9, including the step of further supporting the battery from the arm.

12. The method as set forth in claim 9, including the step of further supporting the solar collector on the post.

13. Lighting apparatus attached to an arm of a conventional real estate sign and extending from a post anchored in the ground for illuminating a sign dependingly supported by a pair of screw elements, said apparatus comprising in combination:
a) at least one panel attached to the arm and extending from the arm;
b) a mounting for a lamp disposed on each panel of said at least one panel;
c) a lamp mounted in each of said mountings;
d) a solar collector for collecting solar energy and for generating a charging current; and
e) a battery adapted to be charged by said solar collector for providing electrical power to each of said lamps.

14. The lighting apparatus as set forth in claim 13, including a photocell for selectively interconnecting said battery with each of said lamps during periods of darkness.

15. The lighting apparatus as set forth in claim 13 wherein each panel of said at least one panel is secured to the arm intermediate the screw elements.

16. The lighting apparatus as set forth in claim 13 wherein each panel of said at least one panel includes reflective surfaces for reflecting light from said lamps onto the sign.

17. The lighting apparatus as set forth in claim 13 wherein each of said lamps is of a tubular configuration.

18. The lighting apparatus as set forth in claim 13 wherein each of said mountings is disposed within a partial cylindrical section of said panel.

19. Lighting apparatus supported from an arm of a conventional real estate sign and extending from a post anchored in the ground for illuminating a sign depending from the arm, said lighting apparatus comprising in combination:
a) a first panel extending from the arm;
b) a first light fixture supported by said first panel for illuminating one side of the sign;
c) a second panel extending from the arm;
d) a second light fixture supported by said second panel for illuminating an other side of the sign;
e) at least one battery for providing electrical power to said first and second light fixtures; and
f) at least one solar collector for providing an electrical charging current to said at least one battery.

20. A lighting apparatus as set forth in claim 19 wherein said first panel includes a first bent section for supporting said first light fixture and said second panel includes a second bent section for supporting said second light fixture.
